(19) United States
(12) Patent Application Publication
(10) Pub. No.: US 2013/0232092 A1
(43) Pub. Date: Sep. 5, 2013

(54) SEARCHING TRAVEL ROUTES USING REFINED TRIP PRICES

(71) Applicants: Sergey Georgiev, Sofia (BG); Dimitar Kamenov, Sofia (BG); Ivan Goychev, Sofia (BG); Boyan Manev, Sofia (BG)

(72) Inventors: Sergey Georgiev, Sofia (BG); Dimitar Kamenov, Sofia (BG); Ivan Goychev, Sofia (BG); Boyan Manev, Sofia (BG)

(73) Assignee: VAYANT TRAVEL TECHNOLOGIES LLC, Lewes City, DE (US)

(21) Appl. No.: 13/411,254

(22) Filed: Mar. 2, 2012

(51) Int. Cl. G06F 17/00; G06F 17/30

(52) U.S. Cl. 705/400; 707/752; 707/736; 707/E17.014

(57) ABSTRACT

For each market (defined by a pair of origin and destination cities) that the fare is used for travel, the methods calculate its price (both direct and with add-ons) and its estimated or refined price, which includes YQYR fees, among other fees. The methods then select the top routings along with the best fares on each routing and store them in a database. When a user starts a search query, the methods use the aforementioned database to find the best routings. Solutions with minimal pricing are identified, and a list of fares for each routing is prepared for the user.

### TECHNICAL FIELD

The present subject matter generally relates to travel and, more particularly, relates to estimating or refining trip prices and travel routing.

### BACKGROUND

A modern traveler may find great flight deals on-line by searching the Internet using search engines that are engineered to look for travel keywords. While examining all added taxes and fees, the modern traveler may find that the flight deal is no longer as great after taxes and fees are added to the ticket price, which in many circumstances may dwarf the original deal. It would be appreciated by modern travelers if it were possible to calculate such taxes and fees for disclosure so as to allow them to better assess their travel solutions.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect of the subject matter includes a system form which recites a system for selecting routings based on estimated trip prices. The system comprises a YQYR calculator configured to calculate a YQYR fee, which is added to a base fare price to form an estimated trip price. The system further comprises a routing database configured to store records regarding lists of city pairs. The system additionally comprises routing selection hardware configured to receive a travel query, finding suitable routes using the routing database based on the estimated trip price, and executing a sorting process to select a list of unique routing combinations based on the estimated trip price.

Another aspect of the subject matter includes a method form that recites a method for selecting routings based on estimated trip prices. The method comprises plotting flight paths and storing the flight paths in a flight path database. The method further comprises calculating YQYR fees using the flight paths, which are added to base fare prices to produce estimated trip prices, and generating a database slots file to store the YQYR fees, the base fare prices, and the estimated trip prices. The method additionally comprises generating a routing database with records of city pairs based on the estimated trip prices.

A further aspect of the subject matter includes a computer readable medium form which recites a computer readable medium having stored thereon computer-executable instructions for implementing a method for selecting routings based on estimated trip prices. The method comprises plotting flight paths and storing the flight paths in a flight path database. The method further comprises calculating YQYR fees using the flight paths, which are added to base fare prices to produce estimated trip prices, and generating a database slots file to store the YQYR fees, the base fare prices, and the estimated trip prices. The method additionally comprises generating a routing database with records of city pairs based on the estimated trip prices.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating various pieces of archetypical hardware configured to discover and reserve travel solutions using estimated or refined trip prices, in accordance with various embodiments of the present subject matter; and

FIGS. 2A-2H and 2J-2K are process diagrams illustrating archetypical methods for calculating routes that incorporate YQYR fees, among other fees, via pieces of computing hardware, in accordance with various embodiments of the present subject matter.

### DETAILED DESCRIPTION

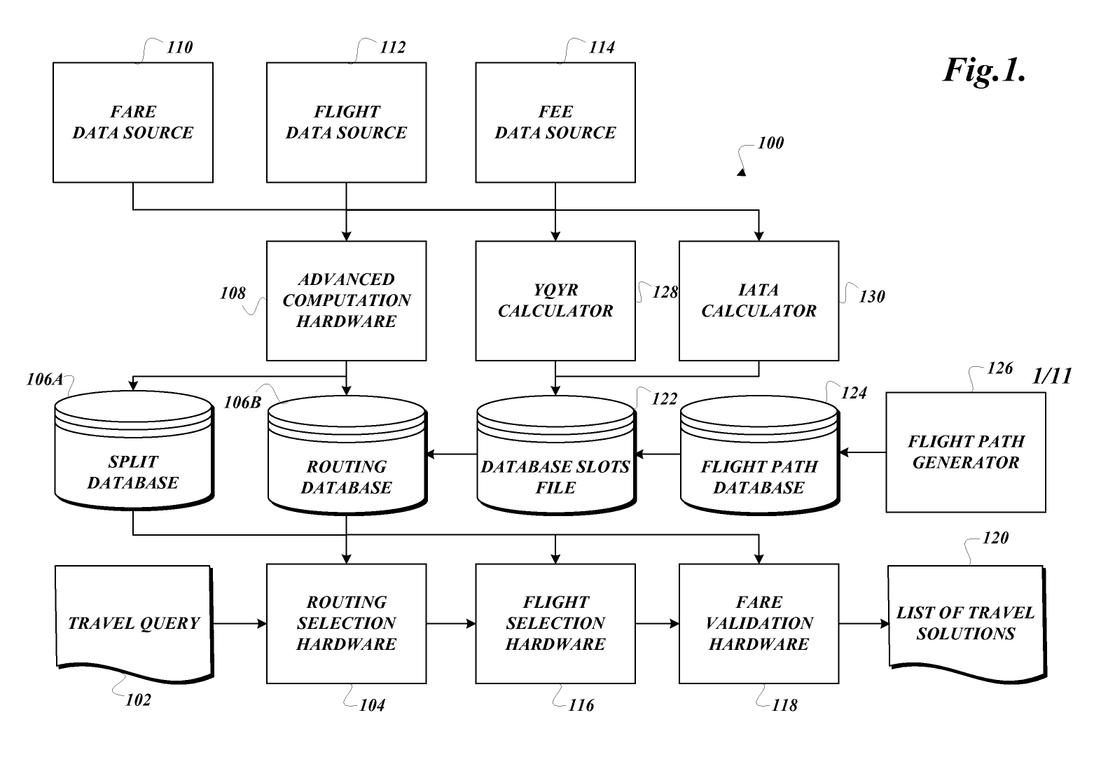

FIG. 1 illustrates pieces of hardware on which pieces of software are executed to implement a system 100 for discovering and reserving travel solutions based on estimated or refined trip prices that account for fees beyond base fare prices. A travel query 102 is presented to routing selection hardware 104. The routing selection hardware 104 uses information in an advanced computation database comprising a split database 106a and a routing database 106b. The records in the advanced computation database can be conceptually divided into records of the split database 106a and records of the routing database 106b. These records are produced by the system 100 via advanced computation hardware 108 and a database slots file 122, which process information taken from a fare data source 110 (using suitable aviation databases, such as ATPCO), a flight data source 112 (using other suitable aviation databases, such as OAG), and a fee data source 114 (using suitable aviation databases, such as TTBS or ATPCO), as well as other data sources, not shown.

The database slots file 122 contains pieces of information taken from a flight path generator 126 which generates flight paths and stores them in a flight path database 124. These flight paths, comprising travel origin points and travel destination points for corresponding fare origins and fare destinations, help to better calculate fees, such as YQYR fees and IATA fees. The flight path generator 126 calculates these travel points for each fare and stores them in the flight path database 124. In other words, for each fare, a direct flight path and its derived constructed or combined flight path is created and stored in the flight path database 124. For constructed or combined flight paths, fare routing allows via points and carriers in the flight paths. The records of the flight path database 124 are accessible by a key that comprises the travel origin point, travel destination point, left gateway, right gateway, and routing number. Each record includes zero or one flight path for each key, and for each flight path, a description of via points and carrier code for each leg of the flight are provided.

A YQYR calculator 128 receives information from sources, such as the fee data source 114, and from other sources, such as the flight paths stored in the flight path database 124, to produce YQYR fee calculations which are stored in the database slots file 122. The YQYR fee calculations are added to base fare prices and these are stored as refined trip prices in the database slots file 122. Similarly, an IATA calculator 130 calculates IATA fees and stores them in the database slots file 122. The IATA fee calculations are also added to the refined trip prices, which are also stored in the database slots file 122. Subsequently, the database slots file 122 and the advanced computation hardware 108 create the routing database 106b, which contains base fare prices along with corresponding YQYR fees and/or IATA fees so as to better estimate refined trip prices. These refined trip prices are then used by the routing selection hardware 104 in executing a sorting process to select a list of unique routing combinations 120 that are suitably less expensive in some embodiments. In other embodiments, the use of refined trip prices may decrease the number of generated routings which results in less computation processing, thereby helping to improve the speed by which consumers receive travel solutions over the Internet. As indicated, the output of the routing selection hardware 104 is the list of unique routing combinations 120, which is presented to the flight selection hardware 116, and subsequently to fare validation hardware 118 to produce a list of travel solutions 120 for consumers over the Internet.

Various embodiments of the present subject matter calculate advanced computation information to estimate fare prices for routes so as to guide the system 100 to produce suitable combinations of travel solutions for travelers or industry participants, such as travel agents. The function of the routing selection software executing on the routing selection hardware 104 is designed not only to run routing selection software, but also to execute defined fare validation and permute routing combinations. The advanced computation database stores advanced computation fares per city pairs. The split database 106a of the advanced computation database stores advanced computation records of split points per city pair. These split points may participate in routing combinations so as to provide desired travel solutions at suitable fare prices to travelers.

The approach of the system 100 in discovering routing combinations is through the use of industry knowledge by the software of the system 100 to find an itinerary with exact flights. While the subject matter, as discussed hereinabove and herein below, is within the context of flight transportation, suitably, the system 100 may integrate data sources including fare data sources for other types of transportation, such as trains, buses, rental vehicles, and so on. The fares applicable for flights are validated in the fare validation hardware 118 against certain suitable business rules. Two suitable sets of business rules include ATPCO and IATA rules, but many other suitable business rules are possible. Such validation also happens in the rule validation steps of the routing selection hardware 104, and finer rule validation steps in the fare validation hardware 118. Although the rule validation steps follow the practices of the travel industry, pieces of software of the system 100 specify how and in which sequence, if any sequence is even necessary, these rules are validated, as well as what approach is used for facilitating computation to return travel solutions to travelers in a time frame that they expect.

The routing database 106b of the advanced computation database contains information of the lists of city pairs, between each of which there is a fare that may be a public, private, or paper fare, and so on. The routing software allows fares from different data sources to be integrated. From a database key formed by origin city, destination city, one-way indicator, round trip indicator, economy/business/first class cabin, carriers, add-ons, YQYR fees, IATA fees, refined trip prices, currency rates, and OAG data, a list of routing identifiers with a list of fares attached to them is stored in the routing database 106b of the advanced computation database. The routing database 106b is used to find suitable routes with suitable fare prices for a city pair that needs to be evaluated further by the pieces of software of the system 100. In various embodiments, these fare prices are refined trip prices that account for fees, such as YQYR fees and/or IATA fees among other fees.

For example, each airline may publish fares between Los Angeles (LAX) and Frankfurt (FRA) on different fare prices, but each of these fare prices contains routing identifiers or numbers which specify the possible intermediary cities (via points) to fly through. As a further example, the airline Lufthansa may specify London (LON) and New York City (NYC) while the airline Air France may specify Frankfurt (FRA) and Amsterdam (AMS). If Lufthansa's fare price is too expensive, then the fare prices through Frankfurt and Amsterdam would be processed by pieces of software being executed after the routing software is executed by the routing selection hardware 104. The advanced computation software running on the advanced computation hardware 108 generates the routing record stored in the routing database 106b together with the database slots file 122, which contain refined trip prices that account for YQYR fees and other fees, and processes published fares in fare aviation databases (such as ATPCO). For each of them, the routing software running on the routing selection hardware 104 verifies travel rules and calculates fare prices. For international fare prices, the process is complicated by the existence of add-on fare prices which could suitably be combined with main fare prices. These combined fare prices are called constructed or combined fare prices.

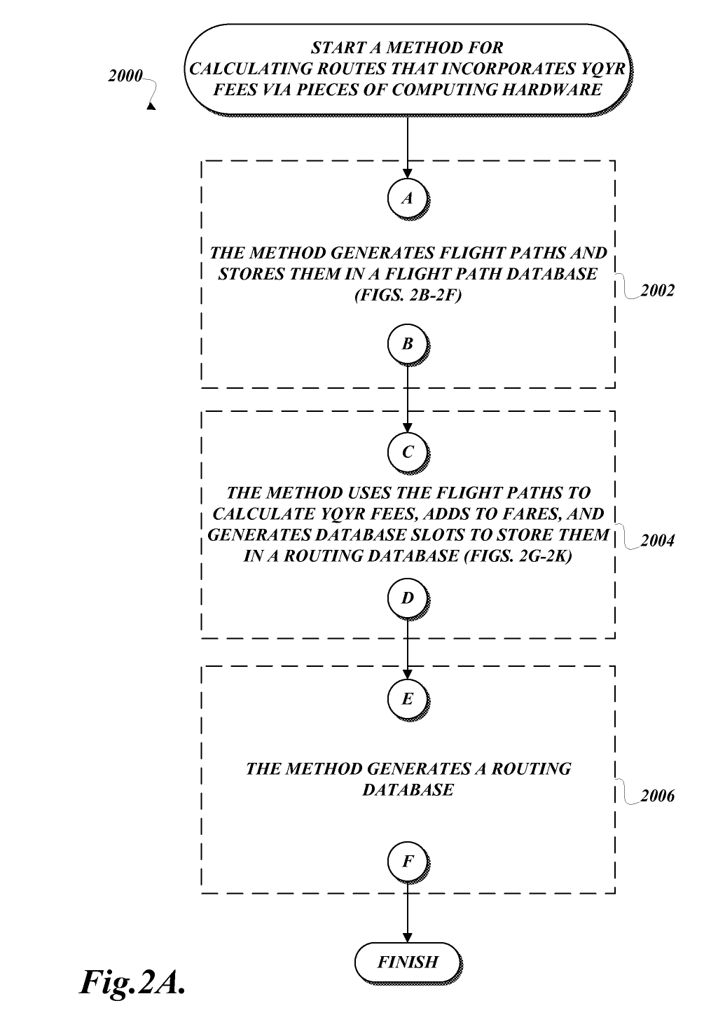

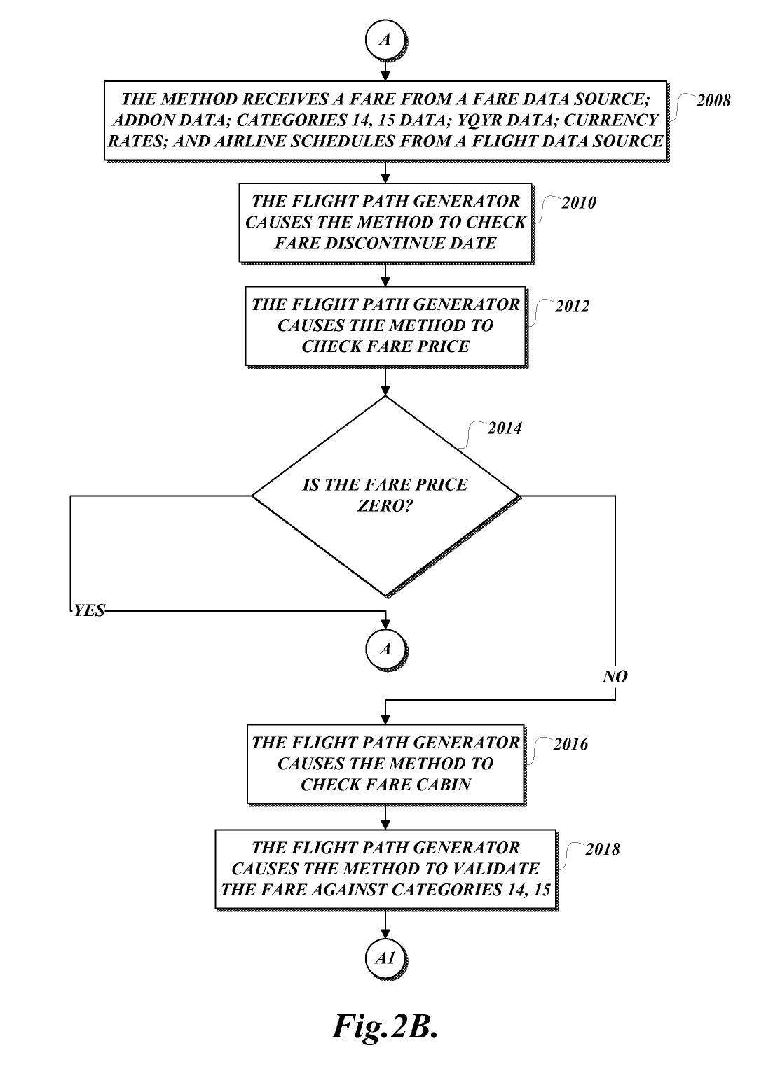

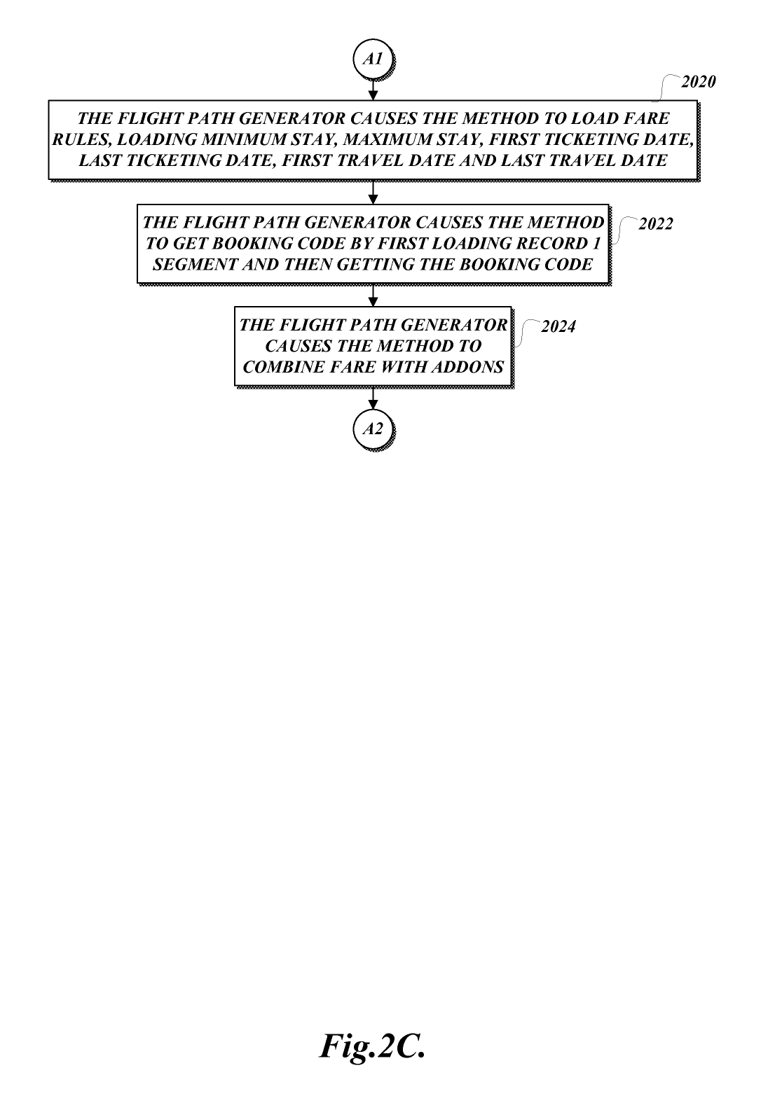

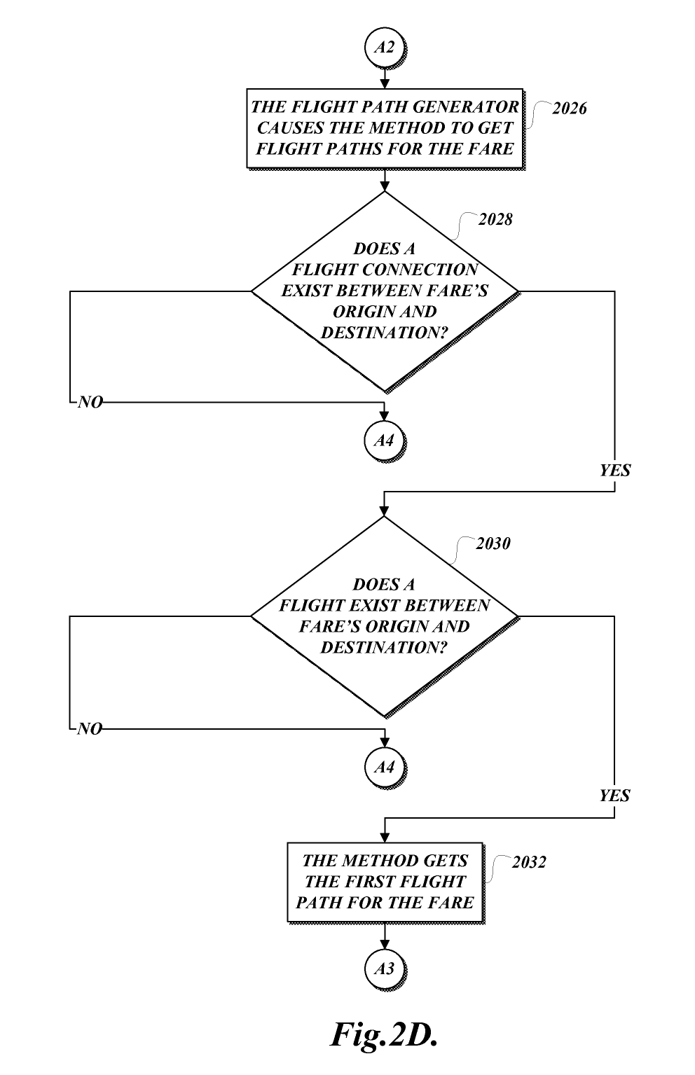

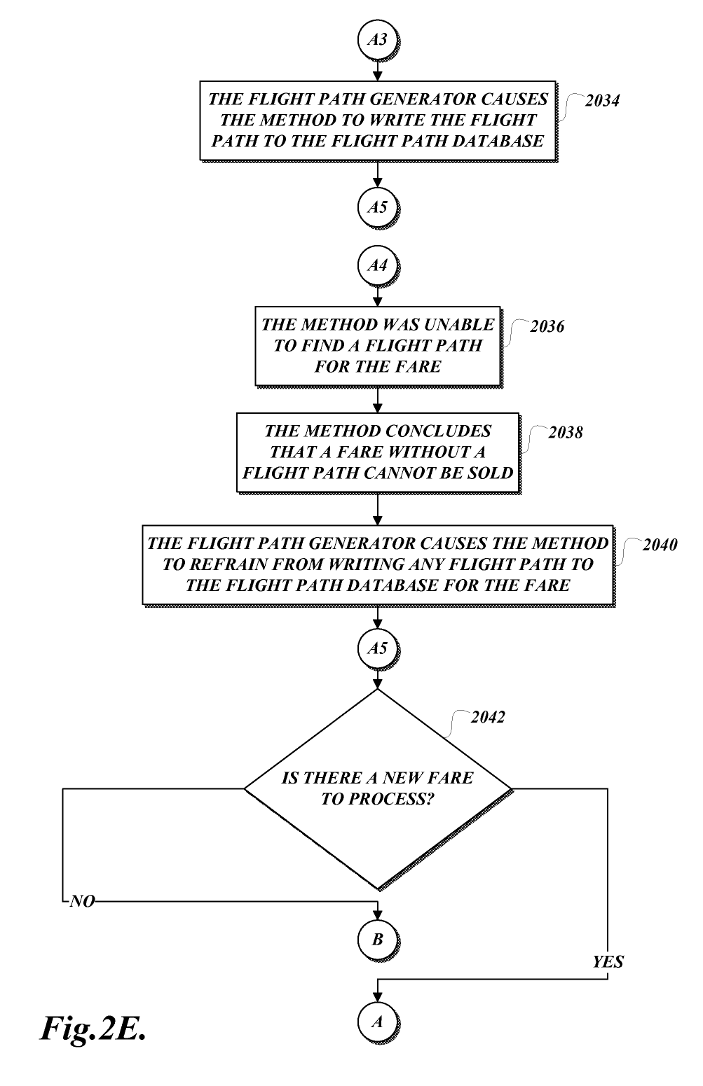

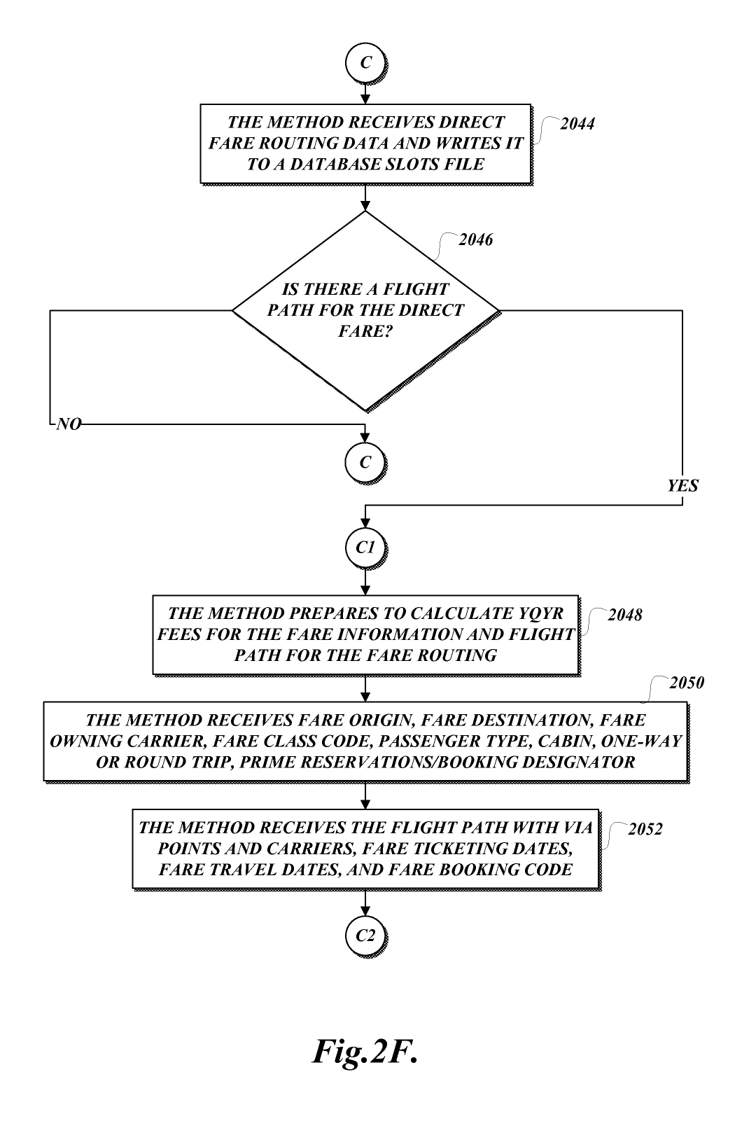

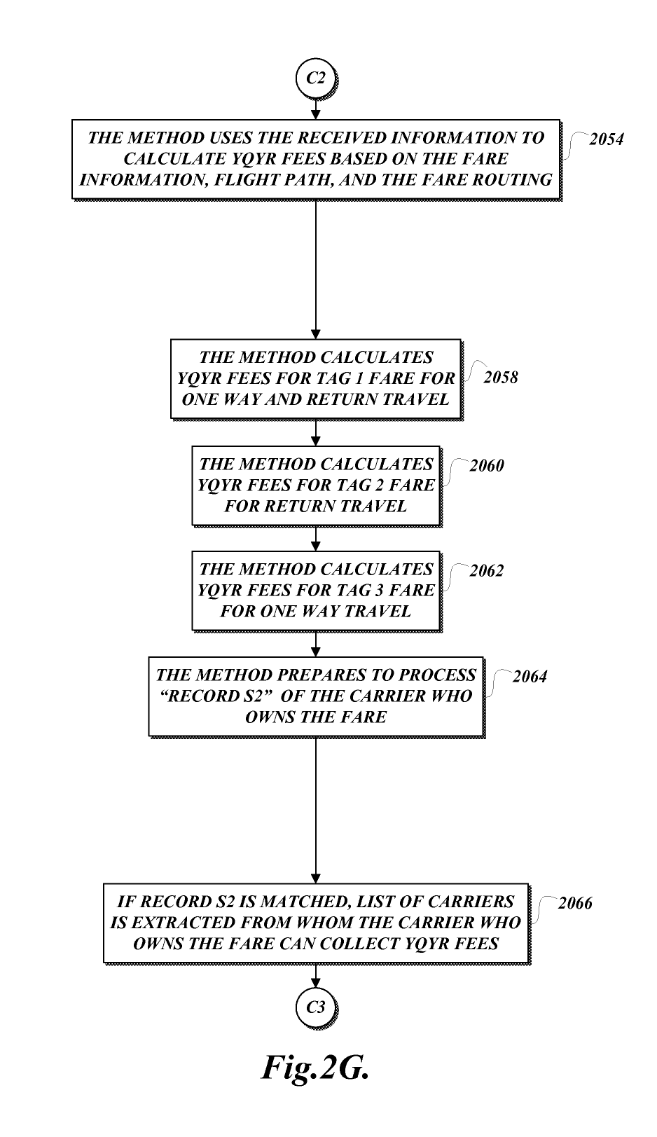

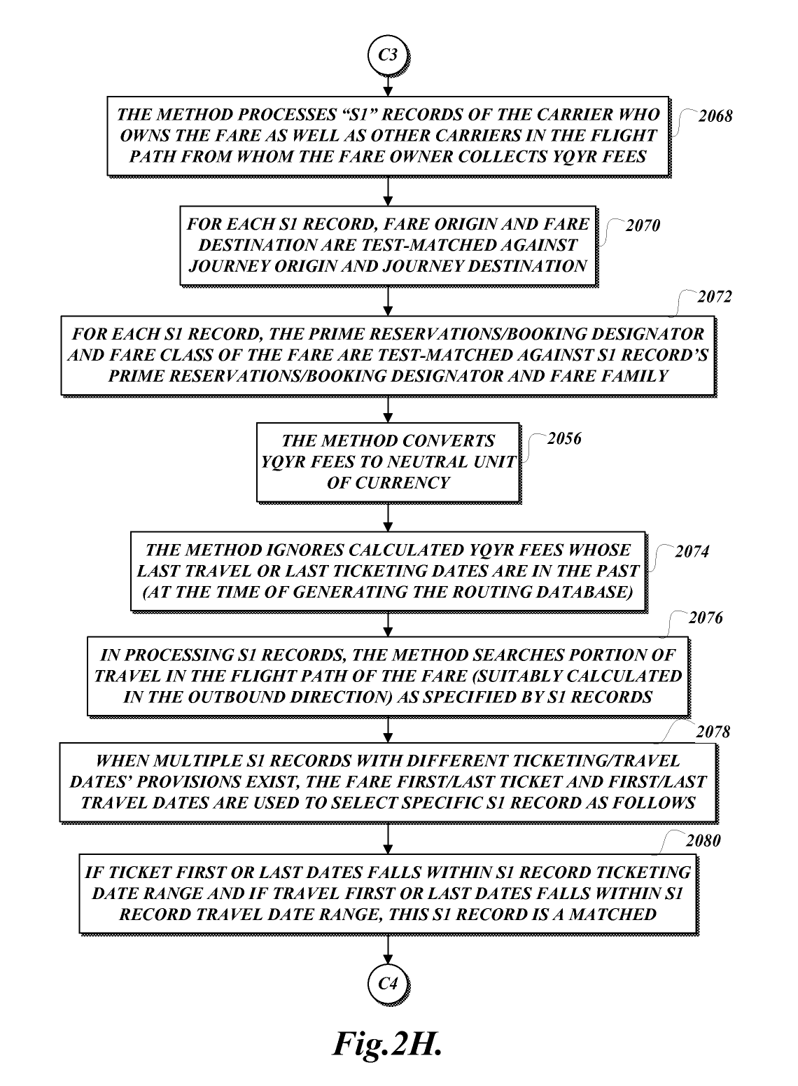

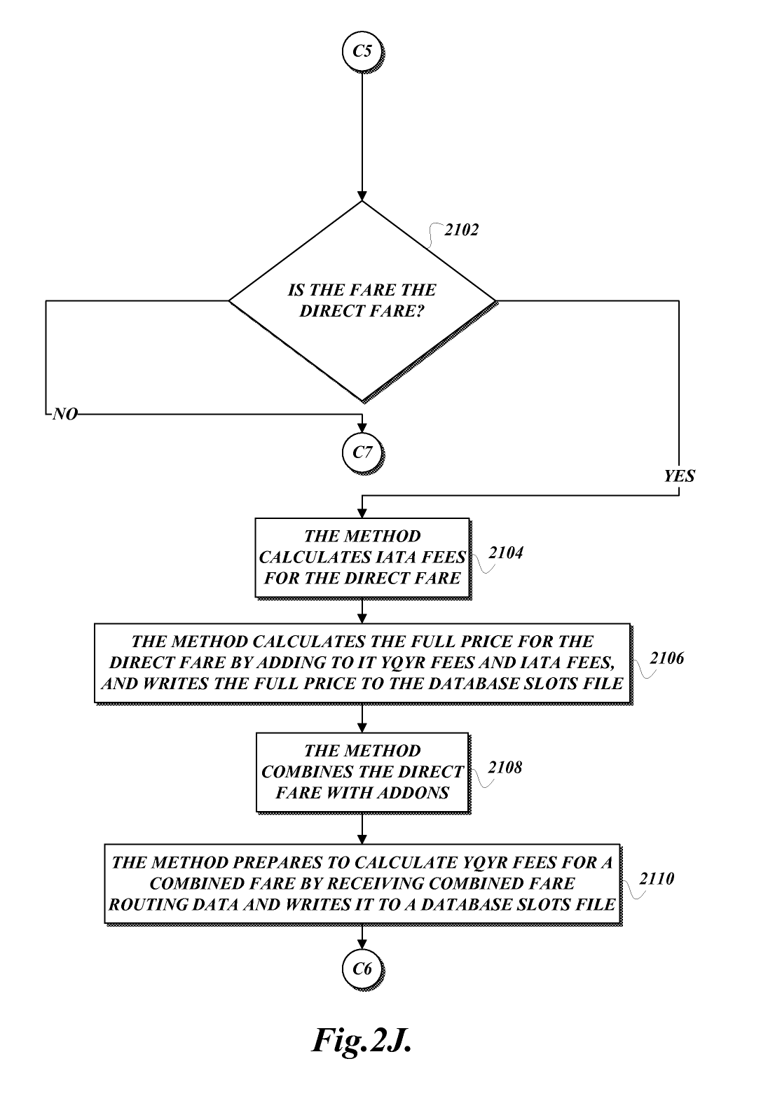

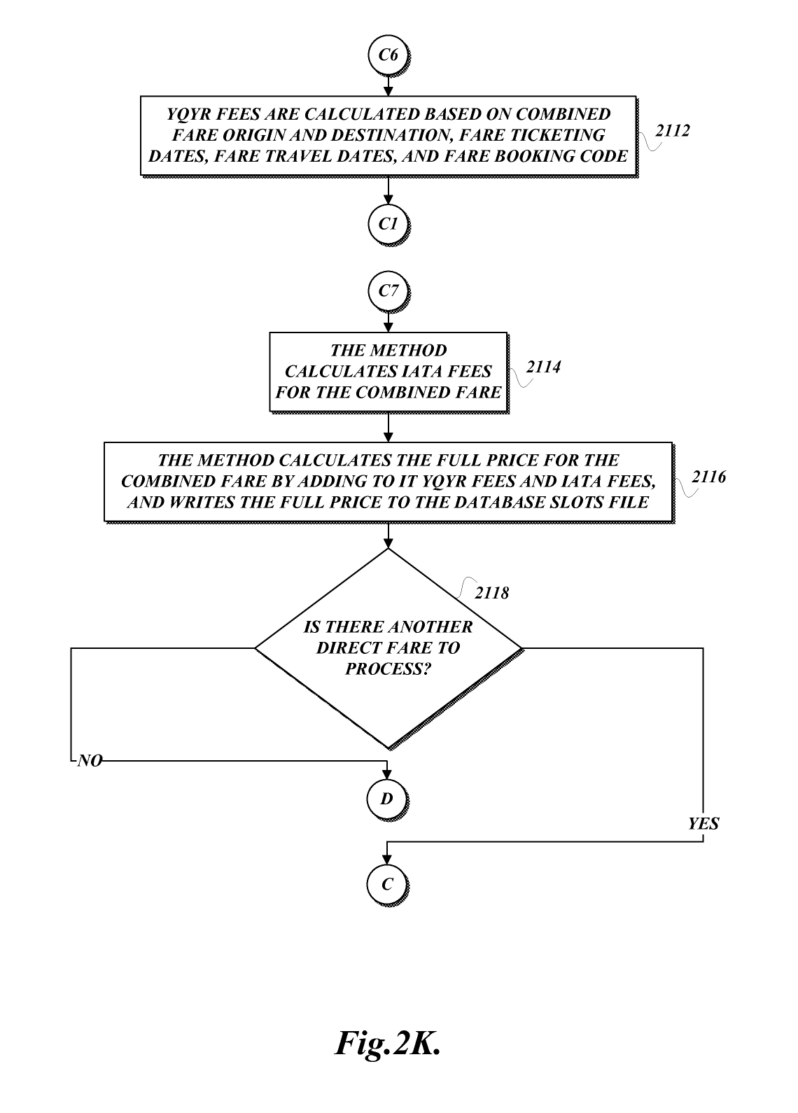

FIGS. 2A-2H and 2-2K illustrate method 2000 for calculating routes that incorporates YQYR fees among other fees via pieces of computing hardware. From the start block, the method 2000 proceeds to a set of method steps 2002, defined between a continuation terminal (“Terminal A”) and an exit terminal (“Terminal B”). The set of method steps 2002 describes generating flight paths and stores them in a flight path database. See FIG. 2A.

From Terminal A (FIG. 2B), the method 2000 proceeds to block 2008 where the method receives a fare from a fare data source; add-on data; categories 14, 15 data; YQYR data; currency rates; and airline schedules from a flight data source. At block 2010, the slots generator causes the method to check the fare discontinue date. At block 2012, the flight path generator causes the method to check fare price. The method then continues to decision block 2014 where a test is performed to determine whether the fare is zero. If the answer to the test at decision block 2014 is Yes, the method skips back to block 2008 where the above-identified processing steps are repeated. Otherwise, the answer to the test at decision block 2014 is No, and the method proceeds to block 2016 where the flight path generator causes the method to check the fare cabin. At block 2018, the flight path generator causes the method to validate the fares against category 14, 15 rules. The method then continues to another continuation terminal (“Terminal A1”).

From Terminal A1 (FIG. 2C), the method proceeds to block 2020 where the flight path generator causes the method to load fare rules, loading minimum stay, maximum stay, first ticketing date, last ticketing date, first travel date, and last travel date. At block 2022, the flight path generator causes the method to get the booking code by first loading the “S1” record segment (or record 1 segment) and then getting the Reservations/Booking Designation (RBD) of the fare. At block 2024, the flight path generator causes the method to combine the fare with add-ons. The method then continues to another continuation terminal (“Terminal A2”).

From Terminal A2 (FIG. 2D), the method 2000 proceeds to block 2026 where the flight path generator causes the method to get flight paths for the fare. The method then continues to decision block 2028 where a test is performed to determine whether a flight connection exists between the fare's origin and destination. If the answer to the test at decision block 2028 is No, the method proceeds to another continuation terminal (“Terminal A4”). Otherwise, the answer to the test at decision block 2028 is Yes, and the method 2000 proceeds to another decision block 2030 where another test is performed to determine whether a flight exists between the fare's origin and destination. If the answer to the test at decision block 2030 is No, the method proceeds to Terminal A4. Otherwise, the answer to the test at decision block 2032 is Yes, and the method gets the first flight path for the fare. The method then continues to another continuation terminal (“Terminal A3”).

From Terminal A3 (FIG. 2E), the method 2000 proceeds to block 2034 where the flight path generator causes the method to write the flight path to the flight path database. The method then continues to another continuation terminal (“Terminal A5”). Regarding Terminal A4 (FIG. 2E), the method 2000 proceeds to block 2036 where the method was unable to find a flight path for the fare. At block 2038, the method concludes that a fare without a flight path cannot be sold. At block 2040, the flight path generator causes the method to refrain from writing any flight path to the flight path database for the fare. The method then continues to continuation Terminal A5 and proceeds to decision block 2042 where a test is performed to determine whether there is a new fare to process. If the answer to the test at decision block 2042 is No, the method continues to exit Terminal B. Otherwise, the answer to the test at decision block 2042 is Yes, the method continues to Terminal A (FIG. 2B), and skips back to block 2008 where the above-identified processing steps are repeated.

From Terminal B (FIG. 2A), the method 2000 proceeds to a set of method steps 2004 where the method uses the flight paths among other pieces of information to calculate YQYR fees among other fees, adds them to the fares, and generates database slots to store them in the database slots file. The set of method steps 2004 is defined between a continuation terminal (“Terminal C”) and an exit terminal (“Terminal D”).

From Terminal C (FIG. 2F), the method 2000 proceeds to block 2044 where the method receives direct fare routing data and writes it to a database slots file. The method then continues to decision block 2046 where a test is performed to determine whether there is a flight path for the direct fare. If the answer to the test at decision block 2046 is No, the method proceeds to Terminal C and skips back to block 2044 where the above-identified processing steps are repeated. Otherwise, the answer to the test at decision block 2046 is Yes, and the method proceeds to another continuation terminal (“Terminal C1”) (FIG. 2F). The method 2000 proceeds to block 2048 from Terminal C1 where the method prepares to calculate YQYR fees for the fare information and flight path for the fare routing. At block 2050, the method receives fare origin, fare destination, fare owning carrier, fare class code, passenger type, cabin, one-way or round trip, and the prime reservations/booking designator. At block 2052, the method receives the flight path with via points and carriers, fare ticketing dates, fare travel dates, and the fare booking code. The fare class code is the code of the fare and often serves as the name of the fare and is used mainly for matching fares and fare families. The method then continues to another continuation terminal (“Terminal C2”).

Digressing, in a few embodiments, to extract or calculate YQYR fees the method performs several validation tests. The first test validates “S2” records. The second test validates “S1” records. The third test validates travel dates against the fare effective date and fare discontinue date. The fourth test validates ticketing dates against the fare first and last allowed ticketing dates. The fifth test validates the carrier (CXR). The sixth test validates a passenger against an adult designation (ADT). The seventh test validates the point of sale against a United States designation. The eighth test validates journey restrictions against a fare flight path. The ninth test validates travel restrictions against the fare flight path. The tenth test validates via restrictions against the fare flight path. The eleventh test validates equipment and skips records which are have equipment restrictions. The twelfth test validates supplier and skips records which have supplier restrictions. The thirteenth test validates flight numbers and skips records which have flight number restrictions. The fourteenth test validates Reservations/Booking Designation (RBD). The fifteenth test validates the Fare Basis Code (FBC) against a fare class.

Returning from the digression, from Terminal C2 (FIG. 2G) the method 2000 proceeds to block 2054 where the method uses the received information to calculate YQYR fees based on the fare information, flight path, and the fare routing. Further digressing, in a few embodiments, the method sets the earliest ticketing date from the category 15 designation as the ticket first date for the fare. The method then continues to a decision block, where a test is performed to determine whether the fare has a category 15 designation or if category 15 fails to specify the earliest ticketing date. If so, the generic flight system (GFS) filing date from the fare record is set as the ticket first date. At a following block, if the fare originates in the United States or Canada, the date of generating the routing database is set as the ticket first date for the fare. At another block, the latest ticketing date from category 15 designation is set by the method as the ticket last date. At a further block, if the fare does not have a category 15 designation or if category 15 fails to specify the latest ticketing date, the method sets the ticket last date to a date well into the future (e.g., Dec. 31, 2049). At an additional block, the method sets the travel first date of the fare to category 14's pricing unit's travel commence date. At a subsequent block, if the fare does not have a category 14 designation or if category 14 does not specify the pricing unit's travel commence date, the travel first date is set to the tariff effective date from the fare record. At yet a further block, if the fare originates in the United States or Canada, the travel first date of the fare is set to the fare's effective date instead of the tariff effective date. At a succeeding block, the method sets the travel last date as the pricing unit's expire date from the category 14 designation. The method then continues to another block where if the fare does not have a category 14 designation or if category 14 does not specify the pricing unit's expire date, the travel last date is set to a date well into the future (e.g., Dec. 31, 2049).

Returning, at block 2058, the method calculates YQYR fees for tag 1 fare for one-way and return travel (stored separately). The method then calculates YQYR fees for tag 2 fare for return travel. See block 2060. At block 2062, the method calculates YQYR fees for tag 3 fare for one-way travel. The fare tags 1, 2, 3 define how the fare may be used. At block 2064, the method prepares to process record S2 of the carrier who owns the fare. At block 2066, if the record S2 is matched, a list of other carriers is extracted, each from whom the carrier who owns the fare can collect YQYR fees. The method then continues to another continuation terminal (“Terminal C3”).

From Terminal C3 (FIG. 2H), the method 2000 proceeds to block 2068 where the method processes “S1” records of the carrier who owns the fare as well as other carriers in the flight path from whom the fare owner collects YQYR fees. At block 2070, for each S1 record, fare origin and fare destination are test-matched against journey origin and journey destination. At block 2072, for each S1 record, the prime reservations/booking designator and fare class of the fare are test-matched against the S1 record's prime reservations/booking designator and fare family. At block 2056, the method converts YQYR fees to a neutral unit of currency. At block 2074, the method ignores calculated YQYR fees whose last travel and last ticketing dates are in the past (at the time of generating the routing database). At block 2076, in processing S1 records, the method searches a portion of travel in the flight path of the fare (suitably calculated in the outbound direction) as specified by S1 records. At block 2078, when multiple S1 records with different ticketing/travel date provisions exist, the fare's first/last ticket and first/last travel dates are used to select a specific S1 record as follows. At block 2080, if ticket first or last dates fall within the S1 record ticketing date range and if travel first or last dates fall within the S1 record travel date range, this S1 record is a match, and the method proceeds to process the next YQYR sub code. Note that YQYR fees can be conceptually divided into two separate fees, YQ and YR. Both have similar processing rules, hence the method 2000 is applicable to both, and it would be appreciated by one skilled in the art that after one fee is processed, such as YQ, the other follows, such as YR, using the same method. The method then continues to another continuation terminal (“Terminal C4”).

From Terminal C4 (FIG. 2J), the method continues to decision block 2102 where a test is performed to determine whether the fare is the direct fare. If the answer to the test at decision block 2102 is No, the method continues to another continuation terminal (“Terminal C7”). Otherwise, the answer to the test at decision block 2102 is Yes, and the method 2000 proceeds to block 2104 where the method calculates IATA fees for the direct fare.

Digressing, to calculate IATA fees, the method 2000 prepares to receive four sets of information. The first set of information is directed to the fare, which includes fare origin and destination city/airport; carrier; fare class; Prime RBD; cabin; one-way or round trip designation; fare price and currency (IATA fees are converted to fare currency); and passenger type, which defaults to adult (ADT). The second set of information is directed to the flight path for the fare, such as “AAE-AH-ALG-BA-LON-BA-ACC,” which recites that the origin city is Annaba, Algeria, then transfers to Houari Boumediene Airport in Algiers, Algeria, and for which a second transfer occurs in London Oxford Airport, in London, England, and then has a destination terminating at the city of Accra, Ghana.

The third set of information is directed to fare rules, which pertain to first and last allowed travel dates; first and last allowed booking dates; first and last allowed ticketing dates; minimum stay period for round trip fares; maximum stay period for round trip fares; and seasonality (start and end date range when fare is valid for travel). The fourth set of information pertains to miscellaneous pieces of information, such as airport codes for all points in the flight path; point of sale; travel dates; connection times; transfer/stopover; flight numbers; equipment type; departure/arrival times; specific booking code; and validating carrier. Note that YQYR fees may be used as a basis for IATA fee calculation so IATA calculation suitably takes into account YQYR fee calculation.

The first piece of miscellaneous information includes airport codes, which unless specified otherwise in the flight path, each city pair suitably has one airport to be used for the IATA fee calculation. Suitably, the airport used is the one with the most OAG flights. (Note: EWR as the IATA designation for Newark City International Airport can be considered separate from city code NYC designation New York City.) The second piece of miscellaneous information includes point of sale, for which the assumption is made for wholly domestic fares that the point of sale is within the same country code. The third piece of miscellaneous information includes travel dates, which for one-way travel, the method uses the date of the search if a specific future date is not mentioned (in other words, the date that the journey begins is used). For round-trip travel, the date of the search for the outbound travel and seven days from this date is used for the return travel (if no specific future dates are mentioned). (It should be noted that IATA fee calculation is unlikely to be affected by the minimum/maximum stay requirements and seasonality factors.) The fourth and fifth pieces of information pertain to connection times and transfer/stopover, for which the assumption exists that via points are same day transfers, except for origin and destination city/airports which are treated as stopovers (for round-trip travel the destination of the Fare Basis Code is also the point of transfer). (An assumption is made in the IATA fee calculation that there are no hidden points or technical stops existing on the itinerary.) The ninth piece of miscellaneous information includes a specific booking code, for which Prime RBD is suitably considered as the specific booking code for all sectors. The tenth piece of miscellaneous information pertains to validating carrier, which is the carrier owning the fare. In calculating IATA fees, fare tags 1, 2, and 3 are used for both one-way and round-trip travel. For one-way travel defined by fare tags 1 and 3, the flight path is considered one-way. For round-trip travel defined by fare tags 1 and 2, the flight path is considered for the outbound journey and the reversed flight path is used for the inbound journey. There are IATA fee exemptions, when specified, such as carriers, origin/destination geographic location fields, and transfer type identifiers. These are likely taken into consideration, when specified, in calculating IATA fees. Exemptions which contain “carrier” but in addition have “flight numbers” should be ignored in one embodiment. Similarly, exemptions containing “departure/arrival times” should be ignored in some embodiments. In many embodiments, the YQYR fees are added to the calculation of the IATA fees based on a schedule, according to an aviation service, such as Amadeus (which advises for which IATA fee codes and carrier's YQ and/or YR fees apply). YQYR fees are suitably converted into currency of the fare. Similarly, IATA fees are converted to the currency of the fare and rounded accordingly.

In a few embodiments, the method calculates the IATA fees for various specific applications. These specific applications likely affect one-way and round-trip travel calculation of IATA fees. Regarding US domestic fee calculations, the default is for the US domestic fee to apply for wholly domestic flight paths within the United States. These calculations include applying a 7.5% fee for each Fare Basis Code amount for flight paths within the continental US, without considering Hawaii and Alaska; applying a 7.5% fee for each Fare Basis Code amount for flight paths wholly within Hawaii or wholly within Alaska; applying a suitable amount of money, such as $8.20, in addition to a suitable percentage fee to the Fare Basis Code amount for flight paths from the continental US to Hawaii, the continental US to Alaska, and flight paths between Hawaii and Alaska. (For flight paths with more than a twelve-hour stop, no fees are calculated since all via points are considered transfers.) Regarding US international fee calculation, if the flight path uses the United States only for via points then no US international fee is calculated. Regarding Canadian fees, the method calculates XG, RC and XQ fees. Regarding Egypt, EG and XK fees are calculated and the maximum amount is kept. Regarding India, JN fees are calculated, and the maximum amount is kept.

Returning from the digression, the method continues to block 2106, where the method calculates the full price for the direct fare by adding to it YQYR fees and IATA fees, and writes the full price to the database slots file. At block 2108, the method combines the direct fare with add-ons. At block 2110, the method prepares to calculate YQYR fees for the combined fare by receiving combined fare routing data and writes it to a database slots file. (Such calculation may use previous steps of the method 2000.) The method then continues to another continuation terminal (“Terminal C6”).

From Terminal C6 (FIG. 2K), the method proceeds to block 2112 where YQYR fees are calculated based on combined fare origin and destination, fare ticketing dates, fare travel dates, and fare booking code. The method then continues to Terminal C1 and skips back to block 2048 where the above-identified processing steps are repeated. From Terminal C7 (FIG. 2K), the method calculates IATA fees for the combined fare. See block 2114. (Calculation of IATA fees may use steps of the method 2000 previously discussed.) At block 2116, the method calculates the full price for the combined fare by adding to it YQYR fees and IATA fees, and writes the full price to the database slots file. The method then continues to decision block 2118, where a test is performed to determine whether there is another direct fare to process. If the answer to the test at decision block 2118 is No, the method continues to exit Terminal D. Otherwise, the answer to the test at decision block 2118 is Yes, and the method continues to Terminal C and skips back to block 2044 where the above-identified processing steps are repeated.

From Terminal D (FIG. 2A), the method 2000 proceeds to a set of method steps 2006 defined between a continuation terminal (“Terminal E”) and an exit terminal (“Terminal F”). The set of method steps 2006 generates a routing database. The routing selection hardware 104 uses the refined trip prices which include YQYR fees and/or IATA fees in addition to the base fare prices and additionally uses other information in the routing database to process, sort, and select routings and routing combinations. While illustrative embodiments have been illustrated and described, it will be appreciated that various changes can be made therein without departing from the spirit and scope of the invention.

1. A system for selecting routings based on estimated trip prices, comprising:
a routing database configured to store records regarding lists of city pairs; and
routing selection hardware configured to receive a travel query, finding suitable routes using the routing database based on an estimated trip price, and executing a sorting process to select a list of unique routing combinations based on the estimated trip price.

2. The system of claim 1, further comprising a YQYR calculator configured to calculate a YQYR fee using first and last allowed ticketing dates instead of ticket issue date, which is added to a base fare price to form the estimated trip price.

3. The system of claim 2, further comprising an IATA calculator configured to calculate an IATA fee using first and last allowed ticketing dates instead of exact travel dates, which is added to the base fare price to form the estimated trip price.

4. The system of claim 3, further comprising a database slots file configured to store base fare prices, YQYR fees, IATA fees, and estimated trip prices.

5. A method for selecting routings based on estimated trip prices, comprising:
plotting, by a piece of hardware, flight paths and storing the flight paths in a flight path database;
calculating, by the piece of hardware or another piece of hardware, YQYR fees using the flight paths and first and last ticketing dates instead of ticket issue date, which are added to base fare prices to produce estimated trip prices; and
generating, by the piece of hardware or another piece of hardware, a routing database with records of city pairs based on the estimated trip prices.

6. The method of claim 5, wherein calculating YQYR fees includes skipping YQYR fees which are validated for flight number restrictions.

7. The method of claim 5, wherein calculating YQYR fees incorporates prime reservations/booking designator instead of reservations/booking designator.

8. The method of claim 5, wherein calculating YQYR fees includes skipping YQYR fees which are validated for equipment restrictions.

9. A tangible computer-readable medium, which is non-transitory, on which computer-executable instructions are stored to execute a method for selecting routings based on estimated trip prices, comprising:
plotting flight paths and storing the flight paths in a flight path database;
calculating YQYR fees using the flight paths and first and last allowed ticketing dates instead of ticket issue date, which are added to base fare prices to produce estimated trip prices; and
generating a routing database with records of city pairs based on the estimated trip prices.

10. The computer-readable medium of claim 9, further comprising calculating IATA fees using first and last allowed travel dates instead of exact travel dates, which are added to base fare prices to produce estimated trip prices.

11-12. (canceled)

13. A method for selecting routings based on estimated trip prices, comprising:
plotting, by a piece of hardware, flight paths and storing the flight paths in a flight path database;
calculating, by the piece of hardware or another piece of hardware, IATA fees using the flight paths and first and last allowed travel dates instead of exact travel dates, which are added to base fare prices to produce estimated trip prices; and
generating, by the piece of hardware or another piece of hardware, a routing database with records of city pairs based on the estimated trip prices.

14. The method of claim 13, wherein calculating IATA fees includes skipping IATA fees which are validated for flight number restrictions.

15. The method of claim 13, wherein calculating IATA fees includes skipping IATA fees which are validated for equipment restrictions.

16. The method of claim 13, wherein calculating IATA fees incorporates prime reservations/booking designator instead of reservations/booking designator.
